(19) United States
(12) Patent Application Publication
(10) Pub. No.: US 2016/0364330 A1
(43) Pub. Date: Dec. 15, 2016

(54) TECHNIQUES FOR AVOIDING CACHE VICTIM BASED DEADLOCKS IN COHERENT INTERCONNECTS

(71) Applicant: Samsung Electronics Co., Ltd., Suwon-si (KR)

(72) Inventor: William Alexander HUGHES, San Jose, CA (US)

(21) Appl. No.: 14/735,125

(22) Filed: Jun. 9, 2015

(51) Int. Cl. G06F 12/08

(52) U.S. Cl. CPC G06F 12/0804; G06F 12/0844; G06F 2212/1021; G06F 2212/1041; G06F 2212/281; G06F 2212/608

(57) ABSTRACT

A system and a method are disclosed to control flow of victim transactions received at a coherent interconnect from a coherent device of a processing system. A victim transaction is received from the coherent device at the coherent interconnect if a value of a first token indicates that at least one victim transaction is available to be received by the coherent interconnect. A victim transaction is available to be received by the coherent interconnect for each increment of the value of the first token greater than zero. The value of the first token is decremented for each victim transaction received by the coherent interconnect from the coherent device. An indication of the value of the first token is sent to the coherent device from the coherent interconnect.

### BACKGROUND

Some bus protocols, such as the ACE protocol of ARM, potentially allow a deadlock in which a cache snoop hits (i.e., address matches) a cache victim transaction in a CPU cluster after the cache victim transaction has already been sent by the CPU cluster. Such a deadlock stalls the snoop transaction until the victim transaction completes. Moreover, in such a situation, a coherent interconnect between the CPU cluster and the destination for the victim transaction cannot complete because the stalled snoop prevents the coherent interconnect from completing transactions.

Another potential deadlock that can occur in an ACE bus protocol is that one transaction in a channel, such as a WriteUnique in the write channel, can block another transaction, such as a WriteBack that is also in the write channel. If the WriteUnique cannot be processed by a coherent interconnect because a prior WriteUnique is stalled waiting for a snoop response and the snoop is stalled in the CPU because it matched a victim request which was sent by the CPU, but is now stuck behind the WriteUnique.

### SUMMARY

Embodiments disclosed herein provide systems and methods that prevent deadlocks that occur in conventional bus protocols, and avoid adverse performance aspects and area increases that are associated conventional solutions to avoid deadlocks. In particular, embodiments disclosed herein provide a token-based flow control between a CPU cluster and a coherent interconnect; an Isochronous (ISOC) flow-control channel between an interconnect request source and destination; a linked-list address serialization technique with victim bypass; and data forwarding from a victim transaction to read/write request.

Some exemplary embodiments provide a method to control flow of victim transactions received at a coherent interconnect from a coherent device of a processing system comprising receiving a victim transaction from the coherent device at the coherent interconnect if a value of a first token indicates that at least one victim transaction is available to be received by the coherent interconnect in which a victim transaction is available to be received by the coherent interconnect for each increment of the value of the first token greater than zero; decrementing at the coherent interconnect the value of the first token for each victim transaction received by the coherent interconnect from the coherent device; incrementing at the coherent interconnect the value of the first token for each victim transaction available to be received by the coherent interconnect from the coherent device; and sending from the coherent interconnect to the coherent device an indication of the value of the first token.

Some exemplary embodiments provide that the coherent interconnect comprises a request port and a destination port, in which case the method further comprises: receiving at the destination port a victim transaction from the requesting port if a value of a second token indicates that at least one queue position at the destination port is available for receiving the victim transaction in which a queue position is available at the destination port for each increment of the second token value greater than zero; decrementing the value of the second token for each victim transaction sent from the request port to the destination port; and sending to the requesting port from the destination port an indication of the value of the second token.

Some exemplary embodiments provide that the victim transaction is sent from the requesting port to the destination port through an isochronous channel of the coherent interconnect.

Some exemplary embodiments further provide linking at the destination port the victim transaction to a transaction previously received at the destination port if the victim transaction comprises a same cache line address as the previously received transaction; merging the linked victim transaction with the previously received transaction; and removing a dependency of the linked victim transaction with the previously received transaction.

In some exemplary embodiments, the coherent device comprises a central processing unit (CPU), a digital signal processor (DSP), a graphics processing unit (GPU) or a memory controller.

In some exemplary embodiments, the coherent device comprises a central processing unit that is part of a CPU cluster in which the CPU cluster comprises a plurality of CPUs, and the coherent interconnect receives from at least one CPU of the CPU cluster a victim transaction if a value of the first token indicates that at least one victim transaction is available to be received by the coherent interconnect in which a victim transaction is available to be received by the coherent interconnect for each increment of the first token value greater than zero. The coherent interconnect decrements the value of the first token for each victim transaction received from the at least one CPU, and the coherent interconnect increments the value of the first token for each victim transaction that is available to be received by the coherent interconnect.

In some exemplary embodiments, the coherent interconnect comprises a destination port, in which case the method further comprises: linking at the destination port a victim transaction to a transaction previously received at the destination port if the victim transaction comprises a same cache line address as the previously received transaction; merging the linked victim transaction with the previously received transaction; and removing a dependency of the linked victim transaction with the previously received transaction.

Some exemplary embodiments provide that the processing system comprises a server system, a computing device, a personal digital assistant (PDA), a laptop computer, a mobile computer, a web tablet, a wireless phone, a cell phone, a smart phone, a digital music player, or a wireline or wireless electronic device.

Some exemplary embodiments provide a system, comprising: a coherent device; and a coherent interconnect coupled to the coherent device. The coherent interconnect is configured to: receive a victim transaction from the coherent device if a value of a first token indicates that at least one victim transaction is available to be received by the coherent interconnect in which a victim transaction is available to be received by the coherent interconnect for each increment of the first token value greater than zero; decrement the value of the first token for each victim transaction received by the coherent interconnect; and increment the value of the first token for each victim transaction is available to be received by to the coherent interconnect.

Some exemplary embodiments provide that the coherent interconnect comprises a requesting port and a destination port. The coherent interconnect is configured to: receive at the destination port a victim transaction from the requesting port if a value of a second token indicates that at least one queue position at the destination port is available for receiving the victim transaction in which a queue position is available for each increment of the second token value greater than zero; decrement the value of the second token for each victim transaction sent from the request port to the destination port; and send to the requesting port from the destination port an indication of the value of the second token.

In some exemplary embodiments, the victim transaction victim is sent from the requesting port to the destination port through an isochronous channel of the coherent interconnect.

In some exemplary embodiments, the coherent interconnect is further configured to: link at the destination port a victim transaction to a transaction previously received at the destination port if the victim transaction comprises a same cache line address as the previously received transaction, merge the linked victim transaction with the previously received transaction, and remove a dependency of the linked victim transaction with the previously received transaction.

Some exemplary embodiments provide that the coherent device comprises a central processing unit (CPU), a digital signal processor (DSP), a graphics processing unit (GPU) or a memory controller.

Some exemplary embodiments provide that the coherent device comprises a central processing unit that is part of a CPU cluster in which the CPU cluster comprises a plurality of CPUs. The coherent interconnect is further configured to: receive from at least one CPU of the CPU cluster a victim transaction if a value of the first token indicates that at least one victim transaction is available to be received by the coherent interconnect in which a victim transaction is available to be received by the coherent interconnect for each increment of the first token value greater than zero, decrement the value of the first token for each victim transaction received from the at least one CPU, and increment the value of the first token for each victim transaction that is available to be received by the coherent interconnect.

In some exemplary embodiments, the coherent interconnect comprises a requesting port and a destination port. The coherent interconnect is configured to: receive at the destination port a victim transaction from the requesting port if a value of a second token indicates that at least one queue position at the destination port is available for receiving the victim transaction in which a queue position being available for each increment of the second token value greater than zero; decrement the value of the second token for each victim transaction sent from the request port to the destination port; and send to the requesting port from the destination port an indication of the value of the second token for each queue position that is available at the destination port.

In some exemplary embodiments, the system comprises a server system, a computing device, a personal digital assistant (PDA), a laptop computer, a mobile computer, a web tablet, a wireless phone, a cell phone, a smart phone, a digital music player, or a wireline or wireless electronic device.

Some exemplary embodiments provide a system, comprising: a coherent device; and a coherent interconnect coupled to the coherent device. The coherent interconnect comprises a requesting port and a destination port, and the coherent interconnect is configured to: receive a victim transaction from the coherent device at the requesting port if a value of a first token indicates that at least one victim transaction is available to be received by the coherent interconnect in which a victim transaction is available to be received by the coherent interconnect for each increment of the first token value greater than zero; decrement the value of the first token for each victim transaction received by the coherent interconnect, increment the value of the first token for each victim transaction is available to be received by to the coherent interconnect, receive at the destination port the victim transaction from the requesting port if a value of a second token indicates that at least one queue position at the destination port is available for receiving the victim transaction in which a queue position is available for each increment of the second token value greater than zero, decrement the value of the second token for each victim transaction sent from the request port to the destination port, and send to the requesting port from the destination port an indication of the value of the second token for each queue position that is available.

In some exemplary embodiments, the victim transaction victim is sent from the requesting port to the destination port through an isochronous channel of the coherent interconnect.

In some exemplary embodiments, the system comprises a server system, a computing device, a personal digital assistant (PDA), a laptop computer, a mobile computer, a web tablet, a wireless phone, a cell phone, a smart phone, a digital music player, or a wireline or wireless electronic device.

Some exemplary embodiments provide an article of manufacture comprising a non-transitory computer-readable storage medium having stored thereon computer-readable instructions that, when executed by a computer-type device, results in a method to control flow of victim transactions received at a coherent interconnect from a coherent device of a processing system comprising receiving a victim transaction from the coherent device at the coherent interconnect if a value of a first token indicates that at least one victim transaction is available to be received by the coherent interconnect in which a victim transaction is available to be received by the coherent interconnect for each increment of the value of the first token greater than zero; decrementing at the coherent interconnect the value of the first token for each victim transaction received by the coherent interconnect from the coherent device; incrementing at the coherent interconnect the value of the first token for each victim transaction available to be received by the coherent interconnect from the coherent device; and sending from the coherent interconnect to the coherent device an indication of the value of the first token.

### BRIEF DESCRIPTION OF THE DRAWINGS

Example embodiments will be more clearly understood from the following detailed description taken in conjunction with the accompanying drawings. The Figures represent non-limiting, example embodiments as described herein.

FIG. 1 depicts an exemplary embodiment of a conventional ACE-based System on a Chip (SoC) and illustrates a potential victim/snoop deadlock that results from a snoop that address matches on a CPU victim;

FIG. 2 depicts the exemplary embodiment of the SoC of FIG. 1 to illustrate another deadlock that can occur under a conventional ACE-based protocol;

FIG. 3 depicts an exemplary embodiment of SoC that prevents snoop/victim deadlocks and non-coherent-writes/coherent PCIe-requests deadlocks according to the subject matter disclosed herein;

FIG. 4A depicts a flow diagram of an exemplary embodiment of a token-based flow control process from the point of view of a CPU core according to the subject matter disclosed herein;

FIG. 4B depicts a flow diagram of an exemplary embodiment of a token-based flow control process from the point of view of a CPU request port (CRP) according to the subject matter disclosed herein;

FIG. 5 depicts an exemplary embodiment of coherent interconnect that provides token-based flow control that is sent through an Isochronous (ISOC) channel between an interconnect request port and a destination port according to the subject matter disclosed herein;

FIG. 6 depicts a flow diagram of an exemplary embodiment of a token-based flow control process using an ISOC channel between an interconnect request port and a destination port according to the subject matter disclosed herein;

FIG. 7 depicts a portion of an exemplary embodiment of a linked list according to the subject matter disclosed herein;

FIG. 8 depicts a flow diagram of an exemplary embodiment of a linked-list process within a CRQ of a coherent interconnect according to the subject matter disclosed herein;

FIG. 9 depicts an exemplary arrangement of system components of a System on a Chip (SoC) that utilizes one or more of the systems and/or techniques disclosed herein to prevent snoop/victim deadlocks and non-coherent-writes/coherent PCIe-requests deadlocks;

FIG. 10 depicts an electronic device that utilizes one or more of the systems and/or techniques disclosed herein to prevent snoop/victim deadlocks and non-coherent-writes/coherent PCIe-requests deadlocks;

FIG. 11 depicts a memory system that utilizes one or more of the systems and/or techniques disclosed herein to prevent snoop/victim deadlocks and non-coherent-writes/coherent PCIe-requests deadlocks;

FIG. 12 depicts a block diagram illustrating an exemplary mobile device 1200 that utilizes one or more of the systems and/or techniques disclosed herein to prevent snoop/victim deadlocks and non-coherent-writes/coherent PCIe-requests deadlocks

FIG. 13 depicts a block diagram illustrating a computing system that utilizes one or more of the systems and/or techniques disclosed herein to prevent snoop/victim deadlocks and non-coherent-writes/coherent PCIe-requests deadlocks; and

FIG. 14 depicts an exemplary embodiment of an article of manufacture comprising a non-transitory computer-readable storage medium having stored thereon computer-readable instructions that, when executed by a computer-type device, results in any of the various techniques and methods to prevent snoop/victim deadlocks and non-coherent-writes/coherent PCIe-requests deadlocks according to the subject matter disclosed herein.

### DESCRIPTION OF EMBODIMENTS

The subject disclosed herein relates coherent interconnect architectures that connect multiple requestors (functional blocks that generate read, write and cache-victim requests) to one or more request destinations (e.g., system memory). Embodiments disclosed herein provide systems and methods that prevent deadlocks that occur in conventional bus protocols, and avoid adverse performance aspects and area increases that are associated conventional solutions to avoid deadlocks. In particular, embodiments disclosed herein provide a token-based flow control between a CPU cluster and a coherent interconnect; an Isochronous (ISOC) flow-control channel between an interconnect request source and destination; a linked-list address serialization technique with victim bypass; and data forwarding from a victim transaction to read/write request.

Various exemplary embodiments will be described more fully hereinafter with reference to the accompanying drawings, in which some exemplary embodiments are shown. As used herein, the word “exemplary” means “serving as an example, instance, or illustration.” Any embodiment described herein as “exemplary” is not to be construed as necessarily preferred or advantageous over other embodiments. The subject matter disclosed herein may, however, be embodied in many different forms and should not be construed as limited to the exemplary embodiments set forth herein. Rather, the exemplary embodiments are provided so that this description will be thorough and complete, and will fully convey the scope of the claimed subject matter to those skilled in the art. In the drawings, the sizes and relative sizes of layers and regions may be exaggerated for clarity.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, fourth etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing. For example, an implanted region illustrated as a rectangle may, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the claimed subject matter.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

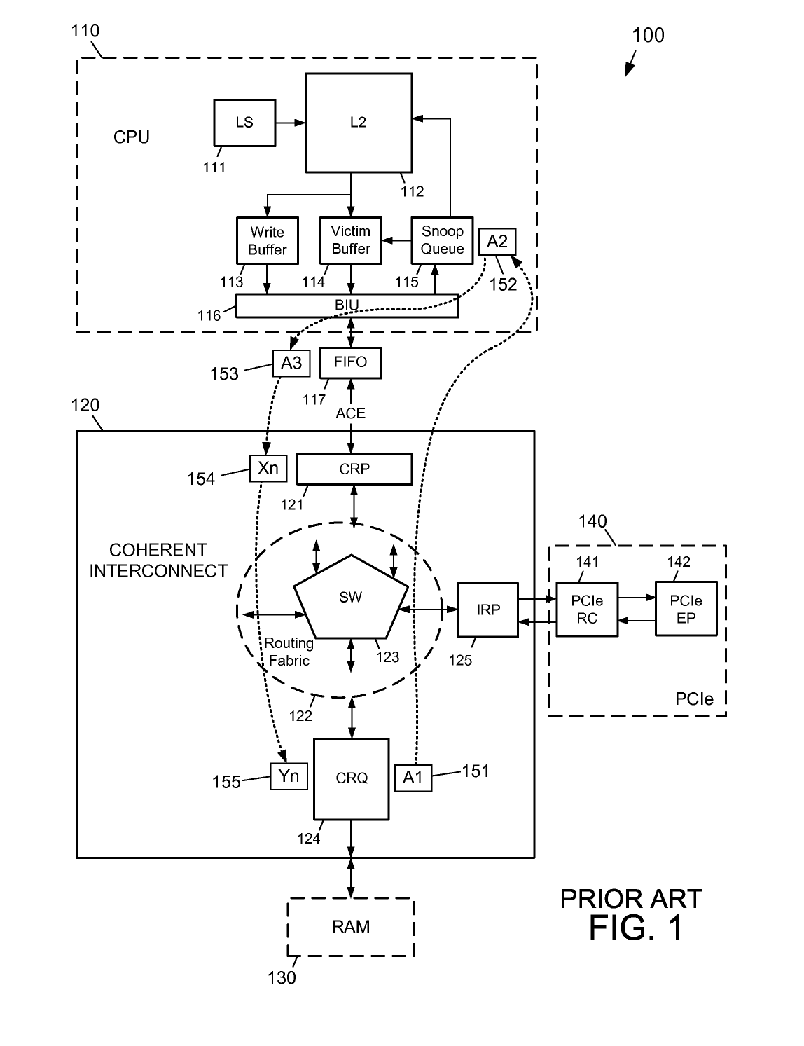

FIG. 1 depicts an exemplary embodiment of a conventional ACE-based System on a Chip (SoC) 100 and illustrates a potential victim/snoop deadlock that results from a snoop that address matches on a CPU victim. As depicted in FIG. 1, SoC 100 comprises a Central Processing Unit (CPU) core 110, a coherent interconnect 120, Random Access Memory (RAM) 130 and a Peripheral Component Interconnect Express (PCIe) bus 140. SoC 100 could comprise other components that are not depicted in FIG. 1.

CPU core 110 comprises a load-store unit (LS) 111, a Level 2 cache (L2) 112, a write buffer 113, a L2 victim buffer 114, snoop queue 115 and bus interface unit (BIU) 116. As depicted in FIG. 1, load-store unit 111 is coupled to L2 cache 112, and L2 cache 112 is coupled to write buffer 113 and victim buffer 114. Write buffer 113 and victim buffer 114 are coupled to BIU 116. BIU 116 is coupled to snoop queue 115. Snoop queue 115 is coupled to L2 cache 112 and to victim buffer 114. CPU core 110 could comprise other components and/or connections that are not depicted in FIG. 1.

BIU 116 couples CPU core 110 to coherent interconnect 120 through, for example, an ACE First In, First Out (FIFO) buffer 117 that is used to cross a clock domain between CPU 110 and coherent interface 120. In one exemplary embodiment, ACE FIFO buffer 117 communicates with coherent interface 120 using a conventional ACE-based protocol.

Coherent interconnect 120 comprises a CPU request port (CRP) 121, a routing fabric 122 comprising one or more switches (SW) 123 and a Coherence Request Queue (CRQ) 124 and a I/O Request Packet (IRP) structure 125. In one exemplary embodiment, at least one switch 123 is coupled to CRQ 124, which resolves cache-coherence actions before accessing a Random Access Memory (RAM) 130, such as, but not limited to, a Dynamic RAM (DRAM). In one exemplary embodiment, at least one switch 123 is coupled to an I/O Request Packet (IRP) structure 125 that is coupled to a Peripheral Component Interconnect (PCI) Express (PCIe) bus 140. Coherent interconnect 120 could comprise other components and/or connections that are not depicted in FIG. 1.

A dependency loop, referred to herein as a victim/snoop deadlock, that stalls operation of SoC 100 can occur during operation of a conventional ACE-based protocol. In particular, CPU core 110 can stall a snoop transaction that matches an address (i.e., address matches) a victim transaction until the victim transaction completes, resulting in a deadlock. For example, consider the following situation in which a Request A1 comprising an address A is in CRQ 124, as indicated at 151 in FIG. 1. In a conventional ACE-based protocol, CRQ 124 issues a snoop transaction A2 to address A. CRQ 124 cannot complete Request A1 until a snoop response is received. Snoop A2 reaches snoop queue 115 at 152 where Snoop A2 address matches a Victim A3 that was previously issued to address A. Accordingly, the snoop transaction will not be processed by CPU core 110 until the victim transaction completes. Victim A3 may be in a pipeline stage between victim buffer 114 and BIU 116, in BIU 116, in a pipeline stage between BIU 116 and an external interface (not shown) of CPU 110, or in FIFO 117 between CPU core 110 and coherent interconnect 120. For this illustration, Victim A3 is depicted at 153 in FIG. 1 in FIFO 117 between CPU core 110 and coherent interconnect 120.

Progress of the victim under the ACE protocol is based on the progress of the write channel, which is controlled at each stage by an AWREADY (write address channel ready) transaction or a WREADY (write data channel ready) transaction. Thus, if the write channel becomes stuck, a victim issued by victim buffer 114, but not yet received by coherent interconnect 120, will also become stuck. Consequently, prior writes that fail to make progress cause Victim A3 to stall.

A number of writes Xn to addresses that are unrelated to the address A of the original Request A1 may be queued in CRP 121. The writes Xn, indicated at 154, may not be able to be issued by CRP 121 if, for example, the destination queue CRQ 124 is full. Thus, the writes Xn occupy all of the CRP resource and block progress of the write channel by forcing the AWREADY transaction to be de-asserted, which causes Victim A3 at 153 to stall. Additionally, CRQ 151 may be full of writes Yn, indicated at 155, that were issued by CRP 121 or by some other request source on the routing fabric. The writes Yn may be stalled behind the original Request A1 if they are competing for the same CRQ resource or if they happen to address match Request A1. Thus, this victim/snoop dependency loop results in a deadlock.

One conventional approach that is used to avoid a victim/snoop deadlock flushes coherent writes before a victim transaction is issued. That is, an ACE CPU core flushes coherent writes by using a WriteUnique transaction or a WriteLineUnique transaction before issuing a victim transaction. A coherent write transaction is dependent on the snoop channel; consequently, a coherent write transaction may become blocked by a snoop and cause a deadlock, as described above. Thus, ensuring that all coherent write transactions are flushed prior to issuing a victim avoids a victim/snoop deadlock. Nevertheless, this conventional approach can cause stalls while the CPU waits for the writes to complete, thereby adversely affecting performance.

Another conventional approach that is used to avoid a victim/snoop deadlock is that an ACE CPU core may convert a coherent write transaction into a CleanUnique transaction followed by a WriteBack transaction. The CleanUnique transaction is used to invalidate other cached copies of a line and the WriteBack transaction is a victim transaction that writes the dirty data to DRAM. Because the CleanUnique transaction is in the read channel (not the write channel) and the WriteBack transaction is a victim transaction that does not generate a snoop, this alternative approach of using CleanUnique/WriteBack transactions avoids a victim/snoop deadlock. This approach, however, results in two transactions being issued instead of one. Moreover, the second transaction serialized behind the first transaction. Accordingly, the two serialized transactions take longer to complete and requires deeper CPU buffers. Also, the Coherent interconnect is required to process two address transactions instead of one, which also results in lower bandwidth.

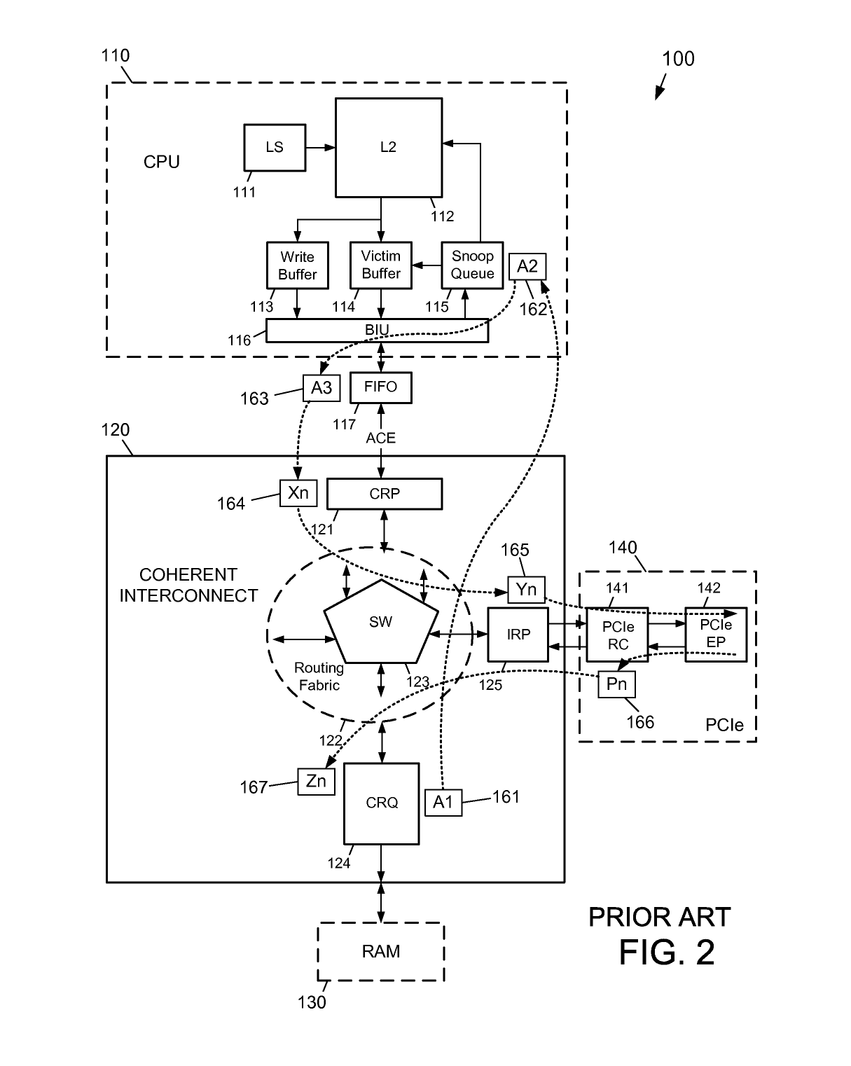

Not only do these two conventional victim/snoop deadlock-avoidance approaches have performance issues, the only writes that are flushed are coherent writes. Non-coherent writes (i.e., WriteNoSnoop transactions) are not flushed prior to issuing a victim transaction under the presumption that a non-coherent write cannot have a dependency on the snoop channel and, thus, cannot result in a victim/snoop deadlock. This presumption, however, breaks down in the presence of a PCIe bus, as illustrated in FIG. 2.

FIG. 2 depicts the exemplary embodiment of SoC 100 of FIG. 1 to illustrate another deadlock that can occur under a conventional ACE-based protocol. In particular, FIG. 2 illustrates a deadlock that can occur for non-coherent writes in the presence of coherent PCIe requests (non-coherent-writes/coherent-PCIe-requests deadlock).

Consider a Request A1 comprising an address A that is in CRQ 124 at 161 in FIG. 2. In a conventional ACE-based protocol, CRQ 124 issues a Snoop A2 to address A. CRQ 124 cannot complete Request A1 until a snoop response is received. At 162, Snoop A2 reaches snoop queue 115 where Snoop A2 address matches a Victim A3 that was previously issued to address A. Thus, the snoop will not be processed by CPU core 110 until the victim transaction completes. Victim A3 may be in a pipeline stage between victim buffer 114 and BIU 116, in BIU 116, in a pipeline stage between BIU 116 and an external interface (not shown) of CPU 110, or in FIFO 117 between CPU core 110 and coherent interconnect 120. For this illustration, Victim A3 at 163 as being stuck in FIFO 117 between CPU core 110 and coherent interconnect 120.

According to the ACE protocol, the progress of the victim is based on the progress of the write channel, which is controlled at each stage by an AWREADY (write address channel ready) transaction or a WREADY (write data channel ready) transaction. Thus, if the write channel becomes stuck, a victim issued by the victim buffer 114, but not yet received by the coherent interconnect 120, will also become stuck. As a result, prior writes that fail to make progress will cause Victim A3 to stall.

A number of writes Xn to addresses that are unrelated to the address A of the original Request Al may be queued in CRP 121. Writes Xn at 164 may not be able to be issued by CRP 121 if, for example, the destination queue IRP 125 is full. Thus, writes Xn occupy all CRP resource and block progress of the write channel by forcing the AWREADY transaction to be de-asserted, which causes Victim A3 to stall.

IRP 125 may be full of non-posted writes Yn at 165 heading downstream through a PCIe root complex (RC) 141 to a PCIe endpoint device (EP) 142. The writes cannot be issued because the PCIe ordering rule is that responses cannot pass prior-posted writes and the resulting responses from the endpoint device 142 are stuck behind upstream PCIe posted writes Pn at 166.

In this second illustration, the upstream PCIe posted writes Pn are targeting CRQ 124 and DRAM 130, and cannot be issued by IRP 125 if the receiving queue CRQ 124 is full. CRQ may be full of writes Zn at 167 that were issued either by the CRP 121, IRP 125 or some other request source on the routing fabric. The writes Zn may be stalled behind the original Request Al if they are competing for the same CRQ resource or if writes An happen to address match Request A1.

For this second illustration, the PCIe loop causes a non-coherent write issued by the CPU core 110 to become dependent on a coherent write from PCIe and, consequently, is subject to the deadlock (a non-coherent-writes/coherent-PCIe-requests deadlock) much like the victim/snoop deadlock illustrated in FIG. 1. The conventional approach to overcoming a non-coherent-writes/coherent-PCIe-requests deadlock, such as that illustrated in FIG. 2, typically provides building a write buffer between IRP 125 and PCIe RC 141 that is deep enough to absorb all possible writes from all CPU cores that may target the PCIe bus 140 so that a victim transaction may now advance to CRQ 124 without being deadlocked. This conventional approach, however, requires a write buffer to be added to SoC 100 causing the corresponding area, power and complexity SoC 100 to increase.

Embodiments disclosed herein overcome snoop/victim deadlocks and non-coherent-writes/coherent PCIe-requests deadlocks (1) without the need to flush prior writes before sending a victim transaction; (2) without the need to convert a single write transaction into a CleanUnique transaction and Writeback transaction, and (3) without the need to provide an external write buffer between an I/O Request Packet (IRP) structure of a coherent interconnect and a root complex (RC) of a PCIe bus that is deep enough to absorb all possible writes from all CPU cores that may target the PCIe bus.

Embodiments of the subject matter disclosed herein use a token-based flow control between a CPU core and a coherent interconnect in which the coherent interconnect releases tokens to the CPU core indicating how many write requests the coherent interconnect can accept. The CPU core does not send a write request unless the CPU core has a token. If the CPU core sends a write, the CPU core decrements a token count. When the coherent interconnect completes a write, the interconnect increments the token count. As a result, a victim transaction cannot be stuck between the CPU core and the coherent interconnect because an available token guarantees that the coherent interconnect can accept the victim transaction. Hence, a victim transaction is either pending issue in the CPU core, in which case a matching snoop transaction is processed by responding with data, or the victim transaction is sent and received by the coherent interconnect at which point the CPU core is allowed to stall a matching snoop. If a victim transaction is sent because a token is available, the victim transaction cannot become stuck between the CPU core and the coherent interconnect, there is no need for the CPU core to flush a WriteUnique queue prior to issuing the victim transaction. Moreover, there is also no need to provide an external write buffer to drain blocking write transactions.

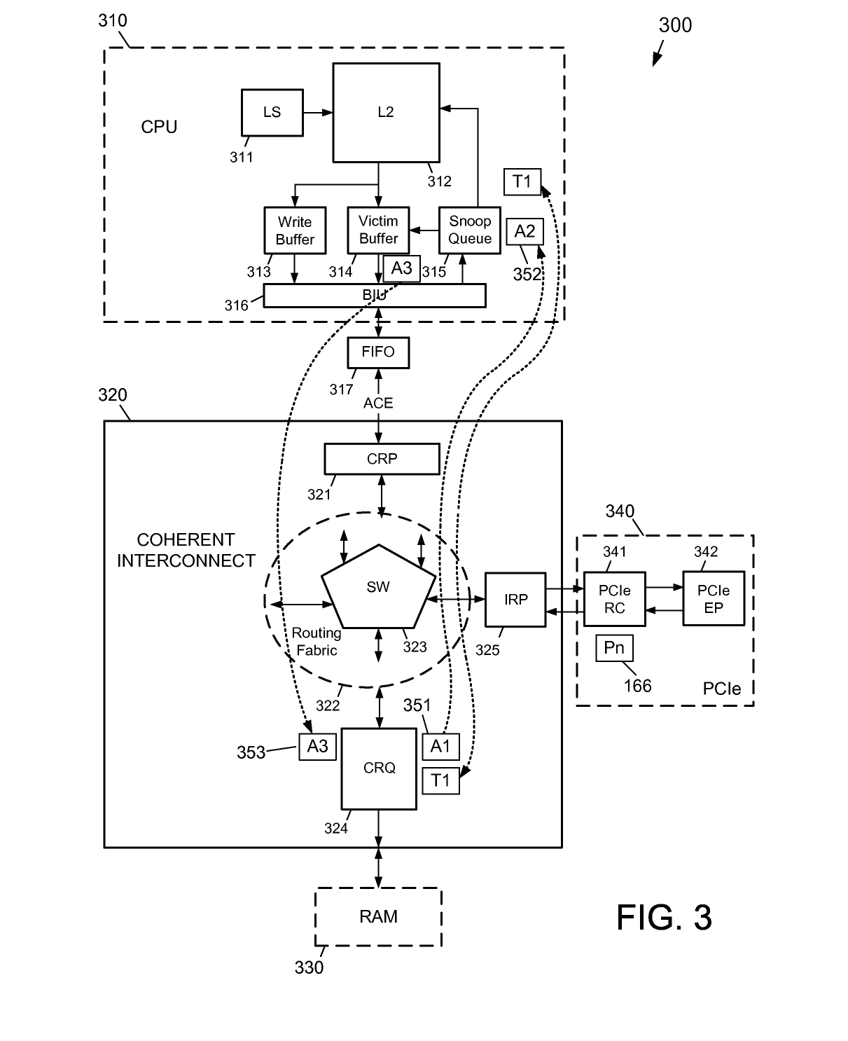

FIG. 3 depicts an exemplary embodiment of SoC 300 that prevents snoop/victim deadlocks and non-coherent-writes/coherent PCIe-requests deadlocks according to the subject matter disclosed herein. SoC 300 comprises a Central Processing Unit (CPU) core 310, a coherent interconnect 320, Random Access Memory (RAM) 330 and a Peripheral Component Interconnect Express (PCIe) bus 340. SoC 300 could comprise other components that are not depicted in FIG. 3.

CPU core 310 comprises a load-store unit (LS) 311, a Level 2 cache (L2) 312, a write buffer 313, a L2 victim buffer 314, snoop queue 315 and bus interface unit (BIU) 316. Load-store unit 311 is coupled to L2 cache 312, and L2 cache 312 is coupled to write buffer 313 and victim buffer 314. Write buffer 313 and victim buffer 314 are coupled to BIU 316. BIU 316 is coupled to snoop queue 315. Snoop queue 315 is coupled to L2 cache 312 and to victim buffer 314. CPU core 310 could comprise other components and/or connections that are not depicted in FIG. 3.

BIU 316 couples CPU core 310 to coherent interconnect 320 through, for example, an ACE First In, First Out (FIFO) buffer 317 that is used to cross a clock domain between CPU 310 and coherent interface 320. In one exemplary embodiment, ACE FIFO buffer 317 communicates with coherent interface 320 using an ACE-based protocol.

Coherent interconnect 320 comprises a CPU request port (CRP) 321, a routing fabric 322 comprising one or more switches (SW) 323 and a Coherence Request Queue (CRQ) 324 and a I/O Request Packet (IRP) structure 325. In one exemplary embodiment, at least one switch 323 is coupled to CRQ 324, which resolves cache-coherence actions before accessing a Random Access Memory (RAM) 330, such as, but not limited to, a Dynamic RAM (DRAM). In one exemplary embodiment, at least one switch 323 is coupled to an I/O Request Packet (IRP) structure 325 that is coupled to a Peripheral Component Interconnect (PCI) Express (PCIe) bus 340. Coherent interconnect 320 could comprise other components and/or connections that are not depicted in FIG. 3.

FIG. 3 illustrates token-based flow control between CPU core 310 and CRP 321 according to the subject matter disclosed herein. Consider a Request A1 comprising an address A that is in CRQ 324 at 351. CRQ 324 issues a Snoop A2 to address A. CRQ 324 cannot complete Request A1 until a snoop response is received. At 352, Snoop A2 reaches snoop queue 315 where Snoop A2 address matches a Victim A3 that was previously issued to address A.

The subject matter disclosed herein adds token-flow control between CPU core 310 and CRP 321, thereby ensuring that a victim transaction is held in victim buffer 314 if there are no tokens, in which case the snoop transaction is not stalled, but instead is processed as a hit and a snoop response that is sent on the snoop-response channel of the CPU core in the same way as if the victim data were still in the CPU cache. If CRP 321 has resources available to handle Victim A3, a token count value T1 is communicated to CPU core 310. The token count value T1 communicates to CPU core 310 whether CRP 321 has available resources to receive a victim transaction and the amount of resources that are available for victim transactions (i.e., there are tokens in the token pool between the CPU and the CRP). If the value of token count T1 is greater than zero, CRP 321 has a queue entry for Victim A3, and CPU core 310 issues a victim transaction for Victim A3. In one exemplary embodiment, the token count value T1 is communicated from CRP 321 to CPU 310 via a sideband signal. In another exemplary embodiment, the ACE READY signal is used to carry the token so that each time a request is de-allocated from CRP 321 a new token release is sent to CPU 310 via a one-cycle assertion of the READY signal. Any write request (i.e., WriteNoSnoop, WriteUnique, WriteLineUnique, WriteBack) can consume a token in the CPU/CRP token pool. If a victim is stuck in the victim buffer 314, the snoop will generate a response. If there are tokens available in the CPU/CRP token pool, the victim cannot get stuck. For the present example, there are tokens in the CPU/CRP token pool and after issuing a victim transaction, CPU core 310 decrements token count value T1 for each victim transaction issued and communicates the decremented token count value back to CRP 321. In an alternative exemplary embodiment, CPU core 310 communicates the occurrence of each decrementing back to CRP 321. If CRP 321 has available capacity (resources) to handle a victim transaction, CRP 321 increments the token count value T1 for each victim transaction for which CRP has resources to handle and communicates the token count value T1 to CPU 310.

The victim transaction makes it to CRP 321 and then, for this example, does not become stuck in the intervening pipeline stages and FIFO between CRP 321 and CRQ 324. Request A1 is forwarded data from Victim A3, which has been waiting in CRQ 324 for a snoop response. If Request A1 is a write transaction, the data of Victim A3 is merged with the write data. If Request A1 is a read transaction, data of Victim A3 is forwarded to a read buffer to be returned to the requestor. In another exemplary embodiment, the victim directly bypasses a write or a read to RAM 330, thereby completing a write or a read that is scheduled after the victim completes.

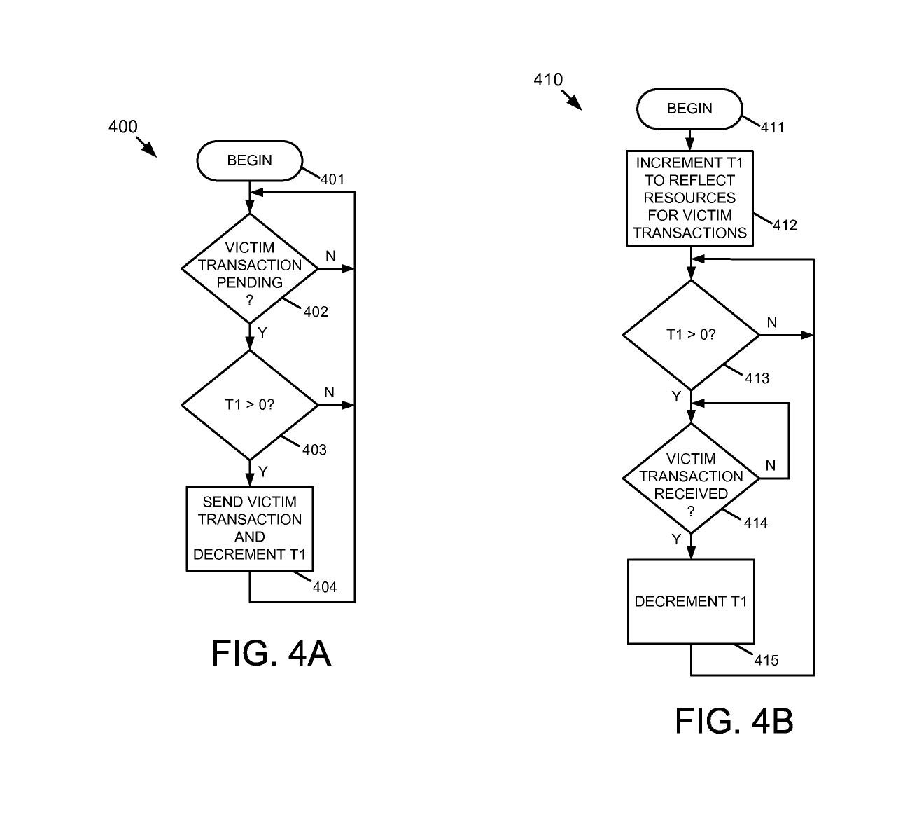

FIG. 4A depicts a flow diagram of an exemplary embodiment of a token-based flow control process 400 from the point of view of a CPU core according to the subject matter disclosed herein. The process begins at operation 401. At operation 402, it is determined whether a victim transaction is pending. If not, flow remains at operation 402. If, at operation 402, a victim transaction is pending, flow continues to operation 403 where it is determined whether the value of token count T1 is greater than 0. If not, flow returns to operation 402. In some exemplary embodiments, the value of token count T1 is received from coherent interconnect 320. If, at operation 403, the value of token count T1 is greater than 0, flow continues to operation 400 where a victim transaction is issued by CPU core 310 and the value of token count T1 is decremented. In some exemplary embodiments, the new value of token count T1 or the occurrence of the value of token count T1 being decremented is communicated to CRQ 324. Flow returns to operation 402.

FIG. 4B depicts a flow diagram of an exemplary embodiment of a token-based flow control process 410 from the point of view of a CRP according to the subject matter disclosed herein. The process beings at operation 411. At operation 412, for each victim transaction that can be handled by CRP 321, the token count value T1 is incremented from 0. In some exemplary embodiments, an indication of the value of token count T1 is sent to CPU core 310. Flow continues to 413 where it is determined whether the value of token count T1 is greater than 0. If, at operation 413, the value of token count T1 is not greater than 0, flow remains at operation 413. If, at operation 413, the value of token count T1 is greater than 0, flow continues to operation 414 where it is determined whether a victim transaction has been received. If not, flow remains at operation 414. If, at operation 414, a victim transaction is received, flow continues to operation 415 where the value of token count T1 is decremented. In some exemplary embodiments, an indication of the token count T1 being decremented is sent to CPU core 310. In other exemplary embodiments, an indication of the value of token count T1 is sent to CPU 310. Flow returns to operation 413.

Thus, token-based flow control according to the subject matter disclosed herein provides that a victim reaches a coherent interconnect without being blocked by prior writes. Although FIGS. 3, 4A and 4B describe token-based flow control between a single CPU core and a single CPU request port (CRP), it should be understood that token-based flow control according to the subject matter disclosed herein can be between any number of CPU cores and any number of CPU request ports (CRPs).

Once a victim transaction is at the CPU request port (CRP), the subject matter disclosed herein provides that the victim transaction can also advance to a system ordering point without being blocked by prior writes. To achieve this, the subject matter disclosed herein uses an Isochronous (ISOC) channel and token-based flow control between an interconnect request port and an interconnect destination port that works in a similar way to token-based flow control for a CPU-interconnect path except that two token pools are maintained—one token pool for writes (TW) and a second token pool for victims (TV). As a result, even if the write channel is blocked (i.e., no tokens are available), a victim transaction may be sent through an Isochronous (ISOC) channel and bypass prior writes to get to the system ordering point. Consequently, even if some number of writes to unrelated addresses are queued in a CRQ that are blocking a base channel, because victim transactions have a dedicated ISOC channel, victim transactions can still be sent to a CRQ regardless of the number of writes to unrelated addesses queued in the CRQ.

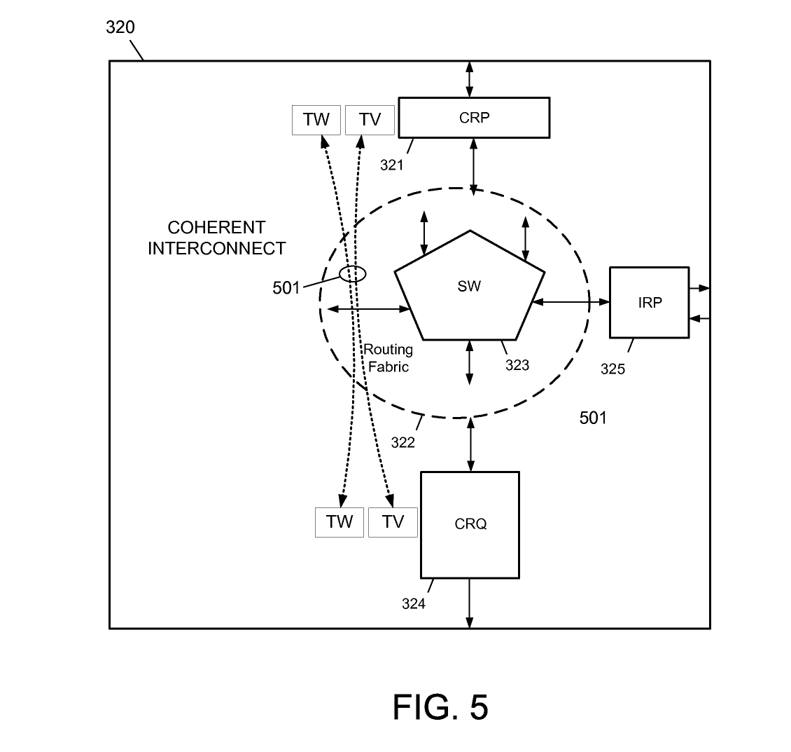

FIG. 5 depicts an exemplary embodiment of coherent interconnect 320 that provides token-based flow control that is sent through an Isochronous (ISOC) channel between an interconnect request port and a destination port according to the subject matter disclosed herein. Coherent interconnect 320 comprises an Isochronous (ISOC) channel 501 through which tokens are incremented or decremented for a token pool for writes (TW) and a token pool for victims (TV).

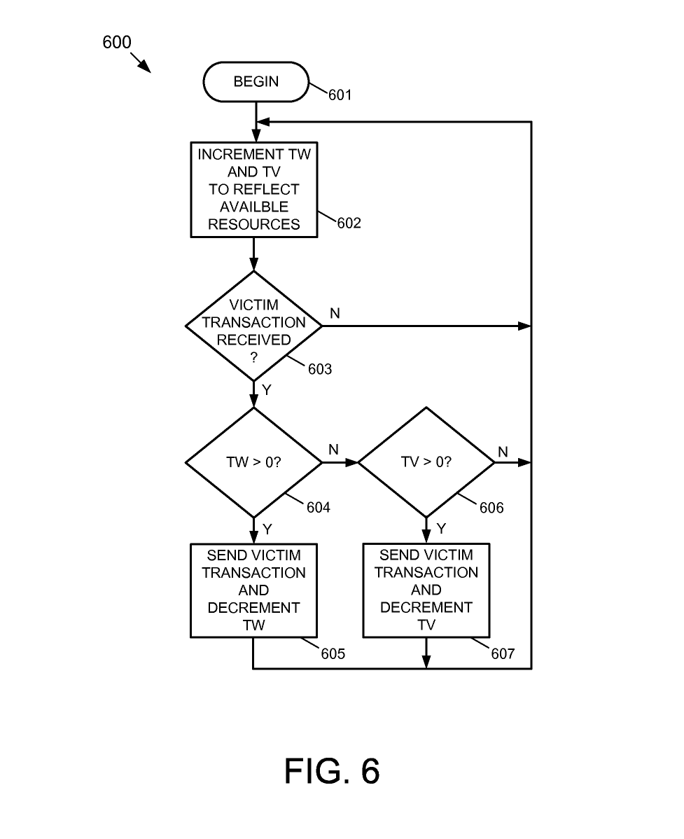

FIG. 6 depicts a flow diagram of an exemplary embodiment of a token-based flow control process 600 using an ISOC channel between an interconnect request port and a destination port according to the subject matter disclosed herein. The process begins at operation 601. At operation 602, for each write transaction that can be handled by the destination port, such as CRQ 324 in FIG. 5, the token count value TW is incremented from 0. Additionally, for each victim transaction that can be handled by the destination port, the token count value TV is incremented from 0. At operation 603, it is determined whether a victim transaction has been received by the request port, such as CRP 321 in FIG. 5. If not, flow returns to operation 602. If, at operation 603, a victim transaction has been received, flow continues to operation 604 where it is determined whether the value of token count TW is greater than 0? If so, flow continues to operation 605 where the victim transaction is sent from the request port to the destination port and the value of token count TW is decremented. Flow returns to operation 602. If, at operation 604, the value of token count TW is not greater than 0, then flow continues to operation 606 where it is determined whether the value of token count TV is greater than 0. If so, flow continues to operation 607 wherein where the victim transaction is sent from the request port to the destination port and the value of token count TW is decremented. Flow returns to operation 602. If, at operation 605, the value of token count TV is not greater than 0, flow returns to operation 602. The exemplary embodiment depicted in FIG. 6 is an optimization. One exemplary embodiment provides that the token count TW is not available to be used by victim transactions, i.e., operations 604 and 605 are omitted, and a victim transaction is only sent from the request port to the destination port (that is, flow is from operation 603 to operation 606.

Although FIGS. 5 and 6 describe ISOC-channel token-based flow control between a single request port and a single destination port within a coherent interconnect, it should be understood that ISOC-channel token-based flow control within a coherent interconnect according to the subject matter disclosed herein can be between any number of request ports and any number of destination ports.

System ordering typically requires that requests to the same cache line address (e.g., same naturally aligned 64B address for a 64B cache line) are serialized so that a later request is not processed until a prior request has been completed. For ACE-based protocols, completion means that a response has been returned to the requestor that acknowledged receipt of the response. This provides that a snoop and a response for the same address cannot collide, which is a requirement of several conventional bus protocols, such as the standard ACE specification.

The subject matter disclosed herein uses a linked-list technique for address serialization of a request arriving at a system serialization point that matches a prior request to the same cache line address. An identification ID of the new request is communicated to the prior request, and when the prior request completes, the prior request uses the ID of the new request to clear the dependency between the two requests. Thus, when a victim transaction arrives at a system ordering point, such as a Coherence Request Queue (CRQ), and one or more address matches are detected (linked) on prior requests, the victim transaction is allowed to bypass to the head of the linked list because the request at the head of the list may be stalled waiting for a snoop to complete and the snoop may be stalled in a CPU core waiting for the victim to complete. Bypassing to the head of the linked list allows the victim to complete ahead of the non-victim requests in the linked list, thereby removing a potential snoop/victim deadlock.

According to embodiments disclosed herein, the linked list provides that requests to, for example, the same cache line of 64-bytet cache block-aligned addresses are serialized so that a second request to a matching address will not be processed until a prior request to the same 64-bytet aligned address completes. Victims are allowed to bypass to the front of the linked list, which provides that victims are always processed when they reach the CRQ irrespective of any prior base channel reads or writes.

Once at the head of the linked-list queue, the victim data is incorporated into any base-channel request in which a snoop has stalled waiting on a victim transaction to complete. Rather than issuing the victim to DRAM and then replaying the read request, the victim data is merged in with the read or write entry at the head of the queue, thereby improving read latency and avoiding unnecessary DRAM accesses.

When the victim bypasses to the head of the linked list, any modified data associated with the victim is merged into the transaction at the head of the linked list to be reflected in the data payload of the request at the head of the list. If the request is a write, the victim data is merged in with the write data so that data payload bytes from the write retain the original write data while data payload bytes that were not written by the write, but are part of the same 64B block, are updated with the victim data. The merged 64-bit block is then written to, for example, DRAM. If the request transaction is a read, the victim data is written to the buffer assigned to hold the read data. If the buffer holds data read from, for example, DRAM, then victim data overwrites the DRAM data. Forwarding the victim data directly to the read or write provides timely transfer of the cache data to the read or write request without requiring a victim write followed by subsequent DRAM read.

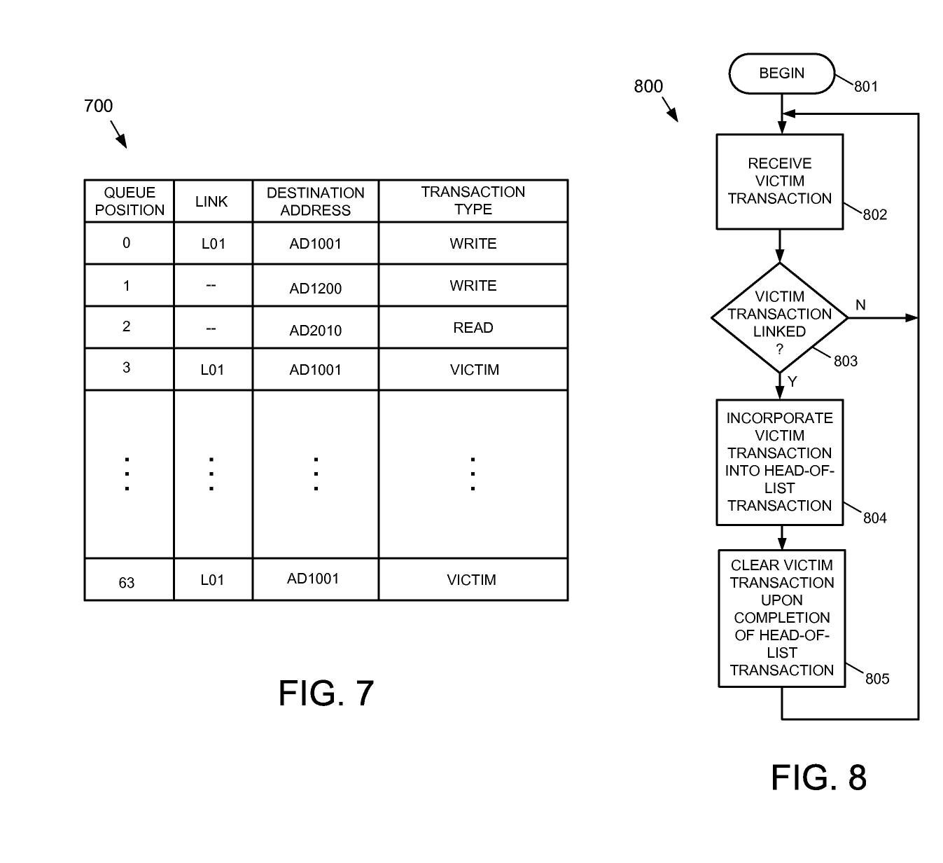

FIG. 7 depicts a portion of an exemplary embodiment of a linked list 700 according to the subject matter disclosed herein. Linked list 700 contains information relating to transactions that have been received at a queue within a CRQ, such as, but not limited to, position in the queue, a link to other transactions in the queue, an address associated with the transaction, and the type of transaction. Transactions are entered into the linked list according to the sequence in which they were received. The destination address of a newly received transaction is compared with destination addresses of transactions already in the CRQ queue to determine whether there are any address matches. If so, linking information is associated with the transactions having the same destination address. In this case, linking information L01 is associated with the transactions at queue locations 0, 3 and 63. In one exemplary embodiment, before the write transaction at queue location 0 completes, the victim transactions at queue locations 3 and 63 update the destination address, the write transaction at queue location 0 completes. In another exemplary embodiment, before the write transaction at queue location completes, the victim transactions at queue locations 3 and 63 are merged with the write transaction at queue location 0, and the victim transactions at locations 3 and 63 are cleared and the available queue locations are updated.

FIG. 8 depicts a flow diagram of an exemplary embodiment of a linked-list process 800 within a CRQ of a coherent interconnect according to the subject matter disclosed herein. The process beings at operation 801. At operation 802, a victim transaction is received at a CRQ of a coherent interconnect. At operation 803, it is determined whether the victim transaction address matches any earlier-received requests. If not, flow returns to operation 803, and the victim transaction is placed in the CRQ. If, at operation 803, it is determined that the victim transaction address matches an earlier-received request, the victim transaction is assigned an ID associated with the queue and advanced to the earlier-received request, thereby bypassing the queue. At operation 804, the victim transaction is incorporated into the earlier-received request. In one exemplary embodiment, the victim transaction is incorporated by updating the destination address of the victim transaction, then completing any linked transactions. Flow continues to operation 805 where the earlier-received request is provided with the ID assigned to the victim transaction and when the prior request completes, the prior request uses the ID of the victim transaction to clear the dependency.

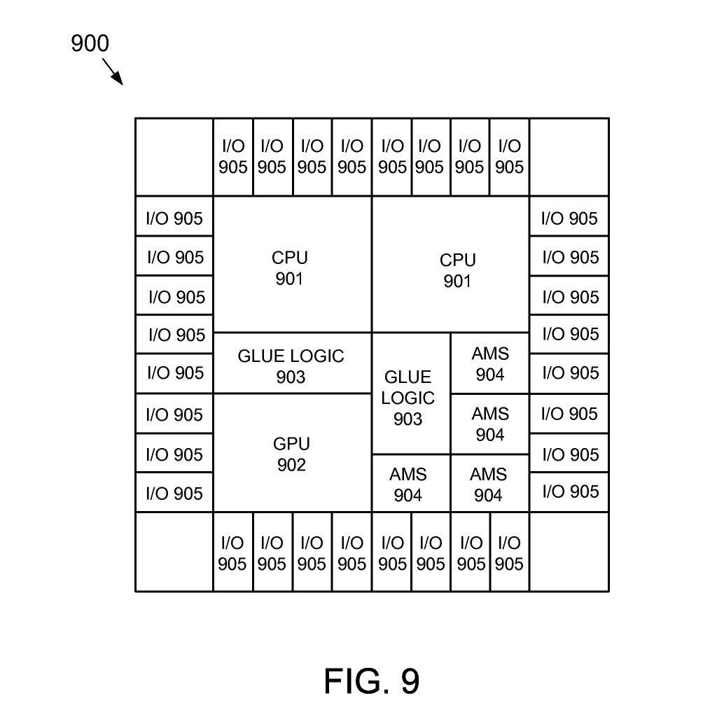

FIG. 9 depicts an exemplary arrangement of system components of a System on a Chip (SoC) 900 that utilizes one or more of the systems and/or techniques disclosed herein to prevent snoop/victim deadlocks and non-coherent-writes/coherent PCIe-requests deadlocks. The exemplary arrangement of SoC 900 comprises one or more central processing units (CPUs) 901, one or more graphical processing units (GPUs) 902, one or more areas of glue logic 903, which can include coherent interconnects, one or more analog/mixed signal (AMS) areas 905, and one or more Input/Output (I/O) areas 905. It should be understood that other arrangements of SoC 900 are possible and that SoC 900 could comprise other system components than those depicted in FIG. 9. SoC 900, which may utilize one or more of the systems and/or techniques disclosed herein to prevent snoop/victim deadlocks and non-coherent-writes/coherent PCIe-requests deadlocks, and may be used in various types of electronic devices, such as, but not limited to, a server system, a computing device, a personal digital assistant (PDA), a laptop computer, a mobile computer, a web tablet, a wireless phone, a cell phone, a smart phone, a digital music player, or a wireline or wireless electronic device.

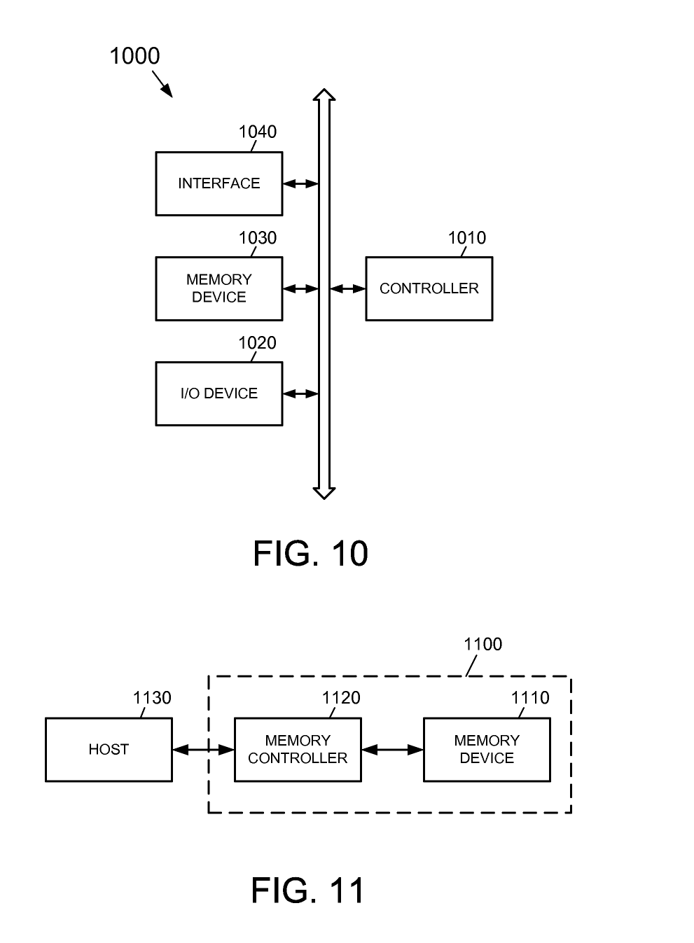

FIG. 10, for example, depicts an electronic device 1000 that utilizes one or more of the systems and/or techniques disclosed herein to prevent snoop/victim deadlocks and non-coherent-writes/coherent PCIe-requests deadlocks. Electronic device 1000 may be used in, but not limited to, a computing device, a server system, a personal digital assistant (PDA), a laptop computer, a mobile computer, a web tablet, a wireless phone, a cell phone, a smart phone, a digital music player, or a wireline or wireless electronic device. The electronic device 1000 may comprise a controller 1010, an input/output device 1020 such as, but not limited to, a keypad, a keyboard, a display, or a touch-screen display, a memory 1030, and a wireless interface 1040 that are coupled to each other through a bus 1050. The controller 1010 may comprise, for example, at least one microprocessor, at least one digital signal process, at least one microcontroller, or the like. The memory 630 may be configured to store a command code to be used by the controller 1010 or a user data. The electronic device 1000 may use a wireless interface 1040 configured to transmit data to or receive data from a wireless communication network using a RF signal. The wireless interface 1040 may include, for example, an antenna, a wireless transceiver and so on. The electronic system 1000 may be used in a communication interface protocol of a communication system, such as, but not limited to, Code Division Multiple Access (CDMA), Global System for Mobile Communications (GSM), North American Digital Communications (NADC), Extended Time Division Multiple Access (E-TDMA), Wideband CDMA (WCDMA), CDMA2000, Wi-Fi, Municipal Wi-Fi (Muni Wi-Fi), Bluetooth, Digital Enhanced Cordless Telecommunications (DECT), Wireless Universal Serial Bus (Wireless USB), Fast low-latency access with seamless handoff Orthogonal Frequency Division Multiplexing (Flash-OFDM), IEEE 802.20, General Packet Radio Service (GPRS), iBurst, Wireless Broadband (WiBro), WiMAX, WiMAX-Advanced, Universal Mobile Telecommunication Service-Time Division Duplex (UMTS-TDD), High Speed Packet Access (HSPA), Evolution Data Optimized (EVDO), Long Term Evolution-Advanced (LTE-Advanced), Multichannel Multipoint Distribution Service (MMDS), and so forth.

FIG. 11 depicts a memory system 1100 that utilizes one or more of the systems and/or techniques disclosed herein to prevent snoop/victim deadlocks and non-coherent-writes/coherent PCIe-requests deadlocks. The memory system 1100 may comprise a memory device 1110 for storing large amounts of data and a memory controller 1120. The memory controller 1120 controls the memory device 1110 to read data stored in the memory device 1110 or to write data into the memory device 1110 in response to a read/write request of a host 1130. The memory controller 1130 may include an address-mapping table for mapping an address provided from the host 1130 (e.g., a mobile device or a computer system) into a physical address of the memory device 1110.

The exemplary SoCs disclosed herein may be encapsulated using various and diverse packaging techniques. For example, the SoCs disclosed herein may be encapsulated using any one of a package on package (POP) technique, a ball grid arrays (BGAs) technique, a chip scale packages (CSPs) technique, a plastic leaded chip carrier (PLCC) technique, a plastic dual in-line package (PDIP) technique, a die in waffle pack technique, a die in wafer form technique, a chip on board (COB) technique, a ceramic dual in-line package (CERDIP) technique, a plastic quad flat package (PQFP) technique, a thin quad flat package (TQFP) technique, a small outline package (SOIC) technique, a shrink small outline package (SSOP) technique, a thin small outline package (TSOP) technique, a thin quad flat package (TQFP) technique, a system in package (SIP) technique, a multi-chip package (MCP) technique, a wafer-level fabricated package (WFP) technique and a wafer-level processed stack package (WSP) technique.

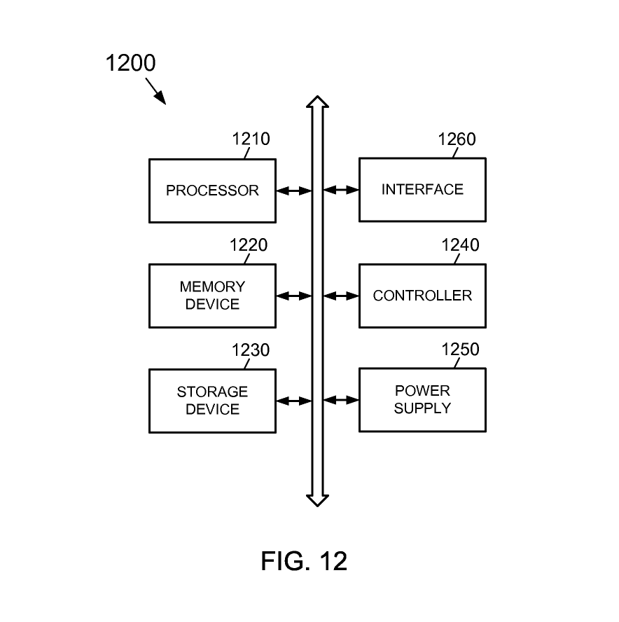

FIG. 12 depicts a block diagram illustrating an exemplary mobile device 1200 that utilizes one or more of the systems and/or techniques disclosed herein to prevent snoop/victim deadlocks and non-coherent-writes/coherent PCIe-requests deadlocks. Referring to FIG. 12, a mobile device 1200 may comprise a processor 1210, a memory device 1220, a storage device 1230, a display device 1240, a power supply 1250 and an image sensor 1260. The mobile device 1200 may further comprise ports that communicate with a video card, a sound card, a memory card, a USB device, other electronic devices, etc.

The processor 1210 may perform various calculations or tasks. According to exemplary embodiments, the processor 1210 may be a microprocessor or a CPU. The processor 1210 may communicate with the memory device 1220, the storage device 1230, and the display device 1240 via an address bus, a control bus, and/or a data bus. In some exemplary embodiments, the processor 1210 may be coupled to an extended bus, such as a peripheral component interconnection (PCI) bus or a PCI Express (PCIe) bus. The memory device 1220 may store data for operating the mobile device 1200. For example, the memory device 1220 may be implemented with, but is not limited to, a dynamic random access memory (DRAM) device, a mobile DRAM device, a static random access memory (SRAM) device, a phase-change random access memory (PRAM) device, a ferroelectric random access memory (FRAM) device, a resistive random access memory (RRAM) device, and/or a magnetic random access memory (MRAM) device. The memory device 1220 comprises a magnetic random access memory (MRAM) according to exemplary embodiments disclosed herein. The storage device 1230 may comprise a solid-state drive (SSD), a hard disk drive (HDD), a CD-ROM, etc. The display device 1240 may comprise a touch-screen display. The mobile device 1200 may further include an input device (not shown), such as a touchscreen different from display device 1240, a keyboard, a keypad, a mouse, etc., and an output device, such as a printer, a display device, etc. The power supply 1250 supplies operation voltages for the mobile device 1200.

The image sensor 1260 may communicate with the processor 1210 via the buses or other communication links. The image sensor 1260 may be integrated with the processor 1210 in one chip, or the image sensor 1260 and the processor 1210 may be implemented as separate chips.

At least a portion of the mobile device 1200 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP). The mobile device 1200 may be a digital camera, a mobile phone, a smart phone, a portable multimedia player (PMP), a personal digital assistant (PDA), a computer, a tablet, etc.

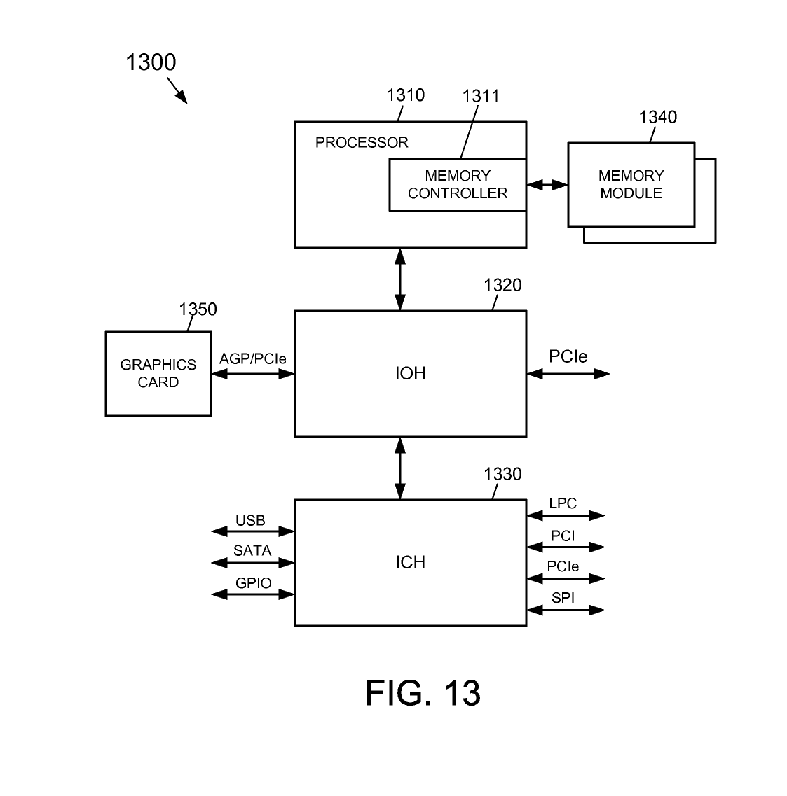

FIG. 13 depicts a block diagram illustrating a computing system 1300 that utilizes one or more of the systems and/or techniques disclosed herein to prevent snoop/victim deadlocks and non-coherent-writes/coherent PCIe-requests deadlocks. Referring to FIG. 13, a computing system 1300 comprises a processor 1310, an input/output hub (IOH) 1320, an input/output controller hub (ICH) 1330, at least one memory module 1340 and a graphics card 1350. In some exemplary embodiments, the computing system 1300 may comprise a server system, a personal computer (PC), a server computer, a workstation, a laptop computer, a mobile phone, a smart phone, a personal digital assistant (PDA), a portable multimedia player (PMP), a digital camera), a digital television, a set-top box, a music player, a portable game console, a navigation system, etc.

The processor 1310 may perform various computing functions, such as executing specific software for performing specific calculations or tasks. For example, the processor 1310 may comprise a microprocessor, a central process unit (CPU), a digital signal processor, or the like. In some embodiments, the processor 1310 may include a single core or multiple cores. For example, the processor 1310 may be a multi-core processor, such as a dual-core processor, a quad-core processor, a hexa-core processor, etc. In some embodiments, the computing system 1300 may comprise a plurality of processors. The processor 1310 may comprise an internal or external cache memory.

The processor 1310 may include a memory controller 1311 for controlling operations of the memory module 1340. The memory controller 1311 included in the processor 1310 may be referred to as an integrated memory controller (IMC). A memory interface between the memory controller 1311 and the memory module 1340 may be implemented with a single channel including a plurality of signal lines, or may bay be implemented with multiple channels, to each of which at least one memory module 1340 may be coupled. In some embodiments, the memory controller 1311 may be located inside the input/output hub 1320, which may be referred to as memory controller hub (MCH).

The input/output hub (IOH) 1320 may manage data transfer between processor 1310 and devices, such as the graphics card 1350. The input/output hub 1320 may be coupled to the processor 1310 via various interfaces. For example, the interface between the processor 1310 and the input/output hub 1320 may be a front side bus (FSB), a system bus, a HyperTransport, a lightning data transport (LDT), a QuickPath interconnect (QPI), a common system interface (CSI), etc. In some exemplary embodiments, the computing system 1300 may comprise a plurality of input/output hubs. The input/output hub 1320 may provide various interfaces with the devices. For example, the input/output hub 1320 may provide an accelerated graphics port (AGP) interface, a peripheral component interface-express (PCIe), a communications streaming architecture (CSA) interface, etc.

The graphics card 1350 may be coupled to the input/output hub 1320 via AGP or PCIe. The graphics card 1350 may control a display device (not shown) for displaying an image. The graphics card 1350 may include an internal processor for processing image data and an internal memory device. In some embodiments, the input/output hub 1320 may include an internal graphics device along with or instead of the graphics card 1350 outside the graphics card 1350. The graphics device included in the input/output hub 1320 may be referred to as integrated graphics. Further, the input/output hub 1320 including the internal memory controller and the internal graphics device may be referred to as a graphics and memory controller hub (GMCH).

The input/output controller hub (ICH) 1330 may perform data buffering and interface arbitration to efficiently operate various system interfaces. The input/output controller hub 1330 may be coupled to the input/output hub 1320 via an internal bus, such as a direct media interface (DMI), a hub interface, an enterprise Southbridge interface (ESI), PCIe, etc. The input/output controller hub 1330 may provide various interfaces with peripheral devices. For example, the input/output controller hub 1330 may provide a universal serial bus (USB) port, a serial advanced technology attachment (SATA) port, a general purpose input/output (GPIO), a low pin count (LPC) bus, a serial peripheral interface (SPI), PCI, PCIe, etc.

In some exemplary embodiments, the processor 1310, the input/output hub 1320 and the input/output controller hub 1330 may be implemented as separate chipsets or separate integrated circuits. In other exemplary embodiments, at least two of the processor 1310, the input/output hub 1320 and the input/output controller hub 1330 may be implemented as a single chipset.

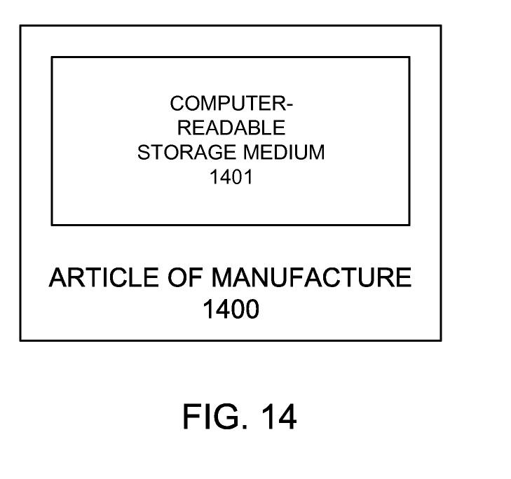

FIG. 14 depicts an exemplary embodiment of an article of manufacture 1400 comprising a non-transitory computer-readable storage medium 1401 having stored thereon computer-readable instructions that, when executed by a computer-type device, results in any of the various techniques and methods to prevent snoop/victim deadlocks and non-coherent-writes/coherent PCIe-requests deadlocks according to the subject matter disclosed herein. Exemplary computer-readable storage mediums that could be used for computer-readable storage medium 1401 could be, but are not limited to, a semiconductor-based memory, an optically based memory, a magnetic-based memory, or a combination thereof.

The foregoing is illustrative of exemplary embodiments and is not to be construed as limiting thereof. Although a few exemplary embodiments have been described, those skilled in the art will readily appreciate that many modifications are possible in the exemplary embodiments without materially departing from the novel teachings and advantages of the present inventive concept. Accordingly, all such modifications are intended to be included within the scope of the appended claims.

What is claimed is:

1. A method to control flow of victim transactions received at a coherent interconnect from a coherent device of a processing system, the method comprising:
receiving a victim transaction from the coherent device at the coherent interconnect if a value of a first token indicates that at least one victim transaction is available to be received by the coherent interconnect, a victim transaction being available to be received by the coherent interconnect for each increment of the value of the first token greater than zero;
decrementing at the coherent interconnect the value of the first token for each victim transaction received by the coherent interconnect from the coherent device;
incrementing at the coherent interconnect the value of the first token for each victim transaction available to be received by the coherent interconnect from the coherent device; and
sending from the coherent interconnect to the coherent device an indication of the value of the first token.

2. The method according to claim 1, wherein the coherent interconnect comprises a request port and a destination port,
the method further comprising:
receiving at the destination port a victim transaction from the requesting port if a value of a second token indicates that at least one queue position at the destination port is available for the victim transaction, a queue position being available at the destination port for each increment of the second token value greater than zero;
decrementing the value of the second token for each victim transaction sent from the request port to the destination port; and
sending to the requesting port from the destination port an indication of the value of the second token.

3. The method according to claim 2, wherein the victim transaction is sent from the requesting port to the destination port through an isochronous channel of the coherent interconnect.

4. The method according to claim 2, further comprising:
linking at the destination port the victim transaction to a transaction previously received at the destination port if the victim transaction comprises a same cache line address as the previously received transaction;
merging the linked victim transaction with the previously received transaction; and
removing a dependency of the linked victim transaction with the previously received transaction.

5. The method according to claim 1, wherein the coherent device comprises a central processing unit (CPU), a digital signal processor (DSP), a graphics processing unit (GPU) or a memory controller.

6. The method according to claim 1, wherein the coherent device comprises a central processing unit that is part of a CPU cluster, the CPU cluster comprising a plurality of CPUs, and
wherein the coherent interconnect receives from at least one CPU of the CPU cluster a victim transaction if a value of the first token indicates that at least one victim transaction is available to be received by the coherent interconnect, a victim transaction being available to be received by the coherent interconnect for each increment of the first token value greater than zero,
wherein the coherent interconnect decrements the value of the first token for each victim transaction received from the at least one CPU, and
wherein the coherent interconnect increments the value of the first token for each victim transaction that is available to be received by the coherent interconnect.

7. The method according to claim 6, wherein the coherent interconnect comprises a destination port,
the method further comprising:
linking at the destination port a victim transaction to a transaction previously received at the destination port if the victim transaction comprises a same cache line address as the previously received transaction;
merging the linked victim transaction with the previously received transaction; and
removing a dependency of the linked victim transaction with the previously received transaction.

8. The method according to claim 6, wherein the processing system comprises a server system, a computing device, a personal digital assistant (PDA), a laptop computer, a mobile computer, a web tablet, a wireless phone, a cell phone, a smart phone, a digital music player, or a wireline or wireless electronic device.

9. A system, comprising:
a coherent device; and
a coherent interconnect coupled to the coherent device, the coherent interconnect being configured to:
receive a victim transaction from the coherent device if a value of a first token indicates that at least one victim transaction is available to be received by the coherent interconnect, a victim transaction being available to be received by the coherent interconnect for each increment of the first token value greater than zero,
decrement the value of the first token for each victim transaction received by the coherent interconnect, and
increment the value of the first token for each victim transaction is available to be received by to the coherent interconnect.

10. The system according to claim 9, wherein the coherent interconnect comprises a requesting port and a destination port, the coherent interconnect being configured to:
receive at the destination port a victim transaction from the requesting port if a value of a second token indicates that at least one queue position at the destination port is available for receiving the victim transaction, a queue position being available for each increment of the second token value greater than zero,
decrement the value of the second token for each victim transaction sent from the request port to the destination port, and
send to the requesting port from the destination port an indication of the value of the second token.

11. The system according to claim 10, wherein the victim transaction victim is sent from the requesting port to the destination port through an isochronous channel of the coherent interconnect.

12. The system according to claim 11, the coherent interconnect is further configured to:
link at the destination port a victim transaction to a transaction previously received at the destination port if the victim transaction comprises a same cache line address as the previously received transaction,
merge the linked victim transaction with the previously received transaction, and
remove a dependency of the linked victim transaction with the previously received transaction.

13. The system according to claim 9, wherein the coherent device comprises a central processing unit (CPU), a digital signal processor (DSP), a graphics processing unit (GPU) or a memory controller.

14. The system according to claim 9, wherein the coherent device comprises a central processing unit that is part of a CPU cluster, the CPU cluster comprising a plurality of CPUs, and
wherein the coherent interconnect is further configured to:
receive from at least one CPU of the CPU cluster a victim transaction if a value of the first token indicates that at least one victim transaction is available to be received by the coherent interconnect, a victim transaction being available to be received by the coherent interconnect for each increment of the first token value greater than zero,
decrement the value of the first token for each victim transaction received from the at least one CPU, and
increment the value of the first token for each victim transaction that is available to be received by the coherent interconnect.

15. The system according to claim 14, wherein the coherent interconnect comprises a requesting port and a destination port, the coherent interconnect being configured to:
receive at the destination port a victim transaction from the requesting port if a value of a second token indicates that at least one queue position at the destination port is available for receiving the victim transaction, a queue position being available for each increment of the second token value greater than zero,
decrement the value of the second token for each victim transaction sent from the request port to the destination port, and
send to the requesting port from the destination port an indication of the value of the second token for each queue position that is available at the destination port.

16. The system according to claim 9, wherein the system comprises a server system, a computing device, a personal digital assistant (PDA), a laptop computer, a mobile computer, a web tablet, a wireless phone, a cell phone, a smart phone, a digital music player, or a wireline or wireless electronic device.

17. A system, comprising:
a coherent device; and
a coherent interconnect coupled to the coherent device, the coherent interconnect comprising a requesting port and a destination port, the coherent interconnect being configured to:
receive a victim transaction from the coherent device at the requesting port if a value of a first token indicates that at least one victim transaction is available to be received by the coherent interconnect, a victim transaction being available to be received by the coherent interconnect for each increment of the first token value greater than zero,
decrement the value of the first token for each victim transaction received by the coherent interconnect;
increment the value of the first token for each victim transaction is available to be received by to the coherent interconnect,
receive at the destination port the victim transaction from the requesting port if a value of a second token indicates that at least one queue position at the destination port is available for receiving the victim transaction, a queue position being available for each increment of the second token value greater than zero,
decrement the value of the second token for each victim transaction sent from the request port to the destination port, and
send to the requesting port from the destination port an indication of the value of the second token for each queue position that is available.

18. The system according to claim 17, wherein the victim transaction victim is sent from the requesting port to the destination port through an isochronous channel of the coherent interconnect.

19. The system according to claim 17, wherein the system comprises a server system, a computing device, a personal digital assistant (PDA), a laptop computer, a mobile computer, a web tablet, a wireless phone, a cell phone, a smart phone, a digital music player, or a wireline or wireless electronic device.
